(19) United States
(12) Patent Application Publication
(10) Pub. No.: US 2025/0330582 A1
(43) Pub. Date: Oct. 23, 2025

(54) BV CANDIDATE CONSTRUCTION USING TEMPORAL CANDIDATE

(71) Applicant: Tencent America LLC, Palo Alto, CA (US)

(72) Inventors: Lien-fei CHEN, Palo Alto, CA (US); Roman CHERNYAK, Santa Clara, CA (US); Xiaozhong XU, State College, CA (US); Shan LIU, San Jose, CA (US)

(73) Assignee: Tencent America LLC, Palo Alto, CA (US)

(21) Appl. No.: 19/256,024

(22) Filed: Jun. 30, 2025

Related U.S. Application Data
(63) Continuation of application No. PCT/US2024/025602, filed on Apr. 20, 2024.
(60) Provisional application No. 63/461,229, filed on Apr. 21, 2023.

(51) Int. Cl. H04N 19/105; H04N 19/137; H04N 19/159; H04N 19/176

(52) U.S. Cl. CPC H04N 19/105; H04N 19/137; H04N 19/159; H04N 19/176

(57) ABSTRACT

Methods and apparatuses for video decoding and video encoding and a method of processing visual media data are described. The apparatus for video decoding includes processing circuitry configured to: receive coded information indicating that a current block in a current picture is predicted according to one of an intra block copy (IBC) mode and an intra template matching prediction (IntraTMP) mode; determine a first temporal block vector (BV) candidate for a BV candidate list of the current block based on one of (i) motion information and (ii) BV information associated with a collocated block in a collocated picture of the current picture; construct the BV candidate list based on the first temporal BV candidate; and reconstruct a current sample based on the BV candidate list using the one of the IBC mode and the Intra TMP mode.

### RELATED APPLICATION

The present application is a continuation of International Application No. PCT/US2024/025602, filed on Apr. 20, 2024, which claims the benefit of priority to U.S. Provisional Application No. 63/461,229, “BV CANDIDATE CONSTRUCTION BY USING TEMPORAL MV” filed on Apr. 21, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of visual media data according to a format rule. The bitstream includes a syntax element indicating that a current block in a current picture is predicted according to one of an intra block copy (IBC) mode and an intra template matching prediction (IntraTMP) mode.

The format rule specifies that a first temporal block vector (BV) candidate for a BV candidate list of the current block is determined based on one of (i) motion information and (ii) BV information associated with a first candidate position of a collocated block.

The format rule specifies that when the one of (i) the motion information and (ii) the BV information is the motion information that indicates a motion vector (MV) and a corresponding reference picture of the collocated picture, a scaled MV is determined based on the MV, a first picture order count (POC) difference between the current picture and the collocated picture, and a second POC difference between the reference picture of the collocated picture and the collocated picture, and the first temporal BV candidate includes the scaled MV.

The format rule specifies that the collocated block is in a collocated picture of the current picture, the BV candidate list is constructed based on the first temporal BV candidate, and a current sample is processed based on the BV candidate list using the one of the IBC mode and the IntraTMP mode.

In an example, the method of processing visual media data includes generating a temporal candidate list including temporal BV candidates associated with respective candidate positions of the collocated block. Each temporal BV candidate is based on one of (i) motion information and (ii) BV information associated with the respective candidate position of the collocated block, and the temporal BV candidates include the first temporal BV candidate. The method of processing visual media data includes applying template-matching (TM) to determine TM costs of the respective temporal BV candidates in the temporal candidate list. The BV candidate list may be constructed based on n1 temporal BV candidates, TM costs of the n1 temporal BV candidates not being larger than one or more TM costs of remaining temporal BV candidates in the temporal candidate list.

In an aspect, a method for video encoding includes determining a first temporal block vector (BV) candidate for a BV candidate list of a current block in a current picture based on one of (i) motion information and (ii) BV information associated with a first candidate position of a collocated block, the collocated block being in a collocated picture of the current picture, the current block being predicted according to one of an intra block copy (IBC) mode and an intra template matching prediction (IntraTMP) mode. The method includes constructing the BV candidate list based on the first temporal BV candidate. The method includes encoding a current sample based on the BV candidate list using the one of the IBC mode and the IntraTMP mode.

In an aspect, the one of (i) the motion information and (ii) the BV information is the motion information that indicates an MV and a corresponding reference picture of the collocated picture. A scaled MV is determined based on the MV, a first POC difference between the current picture and the collocated picture, and a second POC difference between the reference picture of the collocated picture and the collocated picture. In an example, the first temporal BV candidate includes the scaled MV.

In an aspect, when the one of (i) the motion information and (ii) the BV information is the motion information associated with the collocated block, the first temporal BV candidate is determined by averaging multiple pieces of motion information of respective candidate positions associated with the collocated block. When the one of (i) the motion information and (ii) the BV information is the BV information associated with the collocated block, the first temporal BV candidate is determined by averaging multiple pieces of BV information of respective candidate positions associated with the collocated block.

In an aspect, a temporal candidate list including temporal BV candidates associated with respective candidate positions of the collocated block is generated. The temporal BV candidates include the first temporal BV candidate. Each temporal BV candidate may be based on one of (i) the motion information and (ii) the BV information associated with the respective candidate position of the collocated block. The BV candidate list is constructed based on the temporal candidate list.

In an example, the TM is applied to determine TM costs of the respective temporal BV candidates in the temporal candidate list, the temporal BV candidates in the temporal candidate list are reordered based on the respective TM costs, and the BV candidate list is constructed based on the reordered temporal candidate list, for example, by adding the first m reordered temporal candidates from the reordered temporal candidate list to the BV candidate list.

In an example, the TM is applied to determine TM costs of the respective temporal BV candidates in the temporal candidate list. n1 temporal BV candidates are selected based on the TM costs. TM costs of the n1 temporal BV candidates are not larger than the TM cost of each remaining temporal BV candidate in the temporal candidate list. The BV candidate list is constructed based on the n1 selected temporal BV candidates.

In an aspect, the TM is applied to determine TM costs of respective BV candidates in an initial BV candidate list. The BV candidates include the first temporal BV candidate. The BV candidate list is constructed by reordering the BV candidates in the initial BV candidate list based on the respective TM costs. In this example, the initial BV candidate list and the BV candidate list include the same BV candidates that may be arranged in different orders.

According to an aspect of the disclosure, an apparatus for video decoding includes processing circuitry. The processing circuitry is configured to receive coded information indicating that a current block in a current picture is predicted according to one of an intra block copy (IBC) mode and an intra template matching prediction (IntraTMP) mode; determine a first temporal block vector (BV) candidate for a BV candidate list of the current block based on one of (i) motion information and (ii) BV information associated with a collocated block in a collocated picture of the current picture. The processing circuitry is configured to construct the BV candidate list based on the first temporal BV candidate. The processing circuitry is configured to reconstruct a current sample based on the BV candidate list using the one of the IBC mode and the IntraTMP mode.

In an aspect, the first temporal BV candidate is determined based on the one of (i) the motion information and (ii) the BV information associated with a first candidate position of the collocated block.

In an aspect, the one of (i) the motion information and (ii) the BV information is the motion information that indicates an MV and a corresponding reference picture of the collocated picture. A scaled MV is determined based on the MV, a first POC difference between the current picture and the collocated picture, and a second POC difference between the reference picture of the collocated picture and the collocated picture. In an example, the first temporal BV candidate includes the scaled MV.

In an aspect, when the one of (i) the motion information and (ii) the BV information is the motion information associated with the collocated block, the first temporal BV candidate is determined by averaging multiple pieces of motion information of respective candidate positions associated with the collocated block. When the one of (i) the motion information and (ii) the BV information is the BV information associated with the collocated block, the first temporal BV candidate is determined by averaging multiple pieces of BV information of respective candidate positions associated with the collocated block.

In an aspect, a temporal candidate list including temporal BV candidates associated with respective candidate positions of the collocated block is generated. The temporal BV candidates include the first temporal BV candidate. Each temporal BV candidate may be based on one of (i) the motion information and (ii) the BV information associated with the respective candidate position of the collocated block. The BV candidate list is constructed based on the temporal candidate list.

In an example, the TM is applied to determine TM costs of the respective temporal BV candidates in the temporal candidate list, the temporal BV candidates in the temporal candidate list are reordered based on the respective TM costs, and the BV candidate list is constructed based on the reordered temporal candidate list, for example, by adding the first m reordered temporal candidates from the reordered temporal candidate list to the BV candidate list.

In an example, the TM is applied to determine TM costs of the respective temporal BV candidates in the temporal candidate list. n1 temporal BV candidates are selected based on the TM costs. TM costs of the n1 temporal BV candidates are not larger than the TM cost of each remaining temporal BV candidate in the temporal candidate list. The BV candidate list is constructed based on the n1 selected temporal BV candidates.

In an aspect, the TM is applied to determine TM costs of respective BV candidates in an initial BV candidate list. The BV candidates include the first temporal BV candidate. The BV candidate list is constructed by reordering the BV candidates in the initial BV candidate list based on the respective TM costs. In this example, the initial BV candidate list and the BV candidate list include the same BV candidates that may be arranged in different orders.

In an aspect, the TM is applied to determine TM costs of respective BV candidates in the BV candidate list. The BV candidates include the first temporal BV candidate. n2 BV candidates are selected based on the TM costs. The TM costs of the n2 BV candidates are not larger than the TM cost of each remaining BV candidate in the BV candidate list. The current sample may be reconstructed based on the n2 selected BV candidates using the one of the IBC mode and the IntraTMP mode.

In an example, the one of the IBC mode and the IntraTMP mode is the IBC mode. In an example, the one of the IBC mode and the IntraTMP mode is the IntraTMP mode.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of an intra block copy (IBC) mode according to an aspect of the disclosure.

FIG. 5 shows an example of intra picture block compensation with one CTU size search range according to an aspect of the disclosure.

FIG. 6 shows an example of an intra template matching prediction (IntraTMP) mode according to an aspect of the disclosure.

FIG. 7 shows examples of candidate positions for a temporal candidate such as a temporal block vector (BV) candidate according to an aspect of the disclosure.

FIG. 8 shows an example of motion vector (MV) scaling for a temporal BV candidate according to an aspect of the disclosure.

FIG. 9 shows a flow chart outlining a decoding process according to some aspects of the disclosure.

FIG. 10 shows a flow chart outlining an encoding process according to some aspects of the disclosure.

FIG. 11 is a schematic illustration of a computer system in accordance with an aspect.

### DETAILED DESCRIPTION

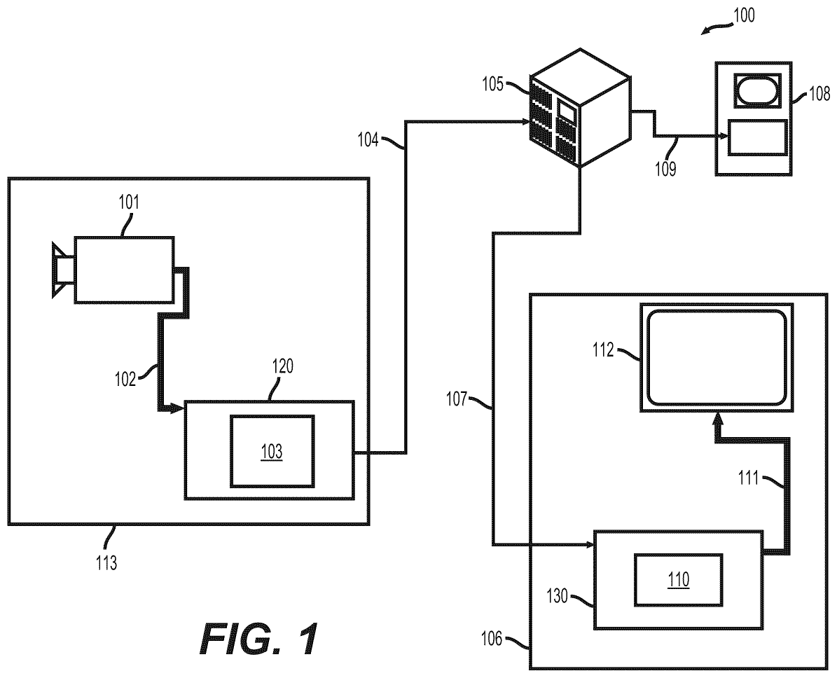

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

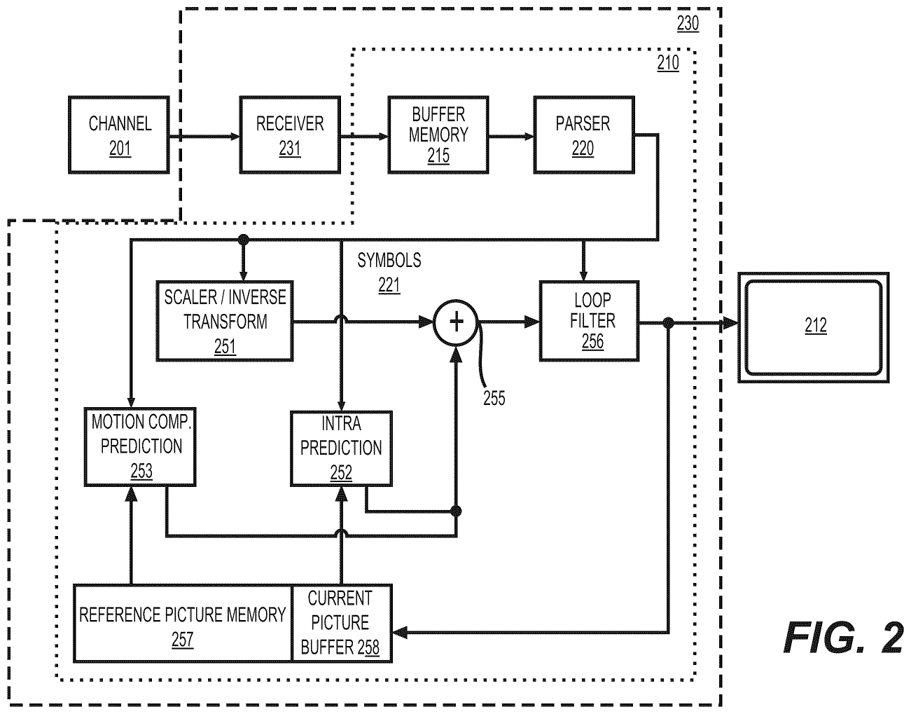

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

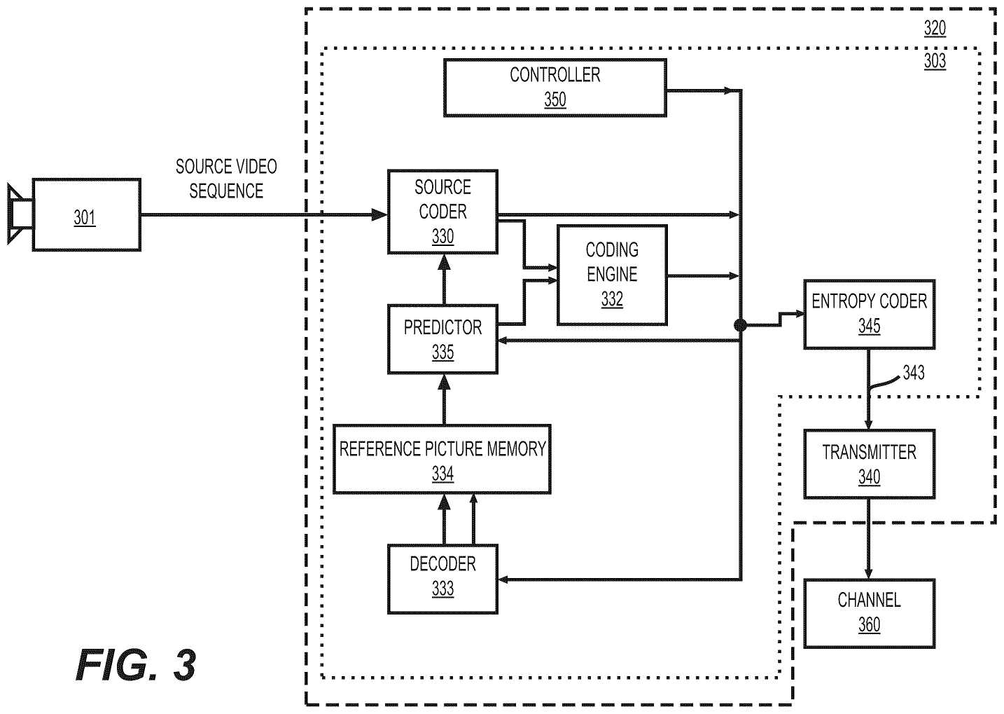

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

In various examples, a current coding frame (interchangeably referred to as a current frame, or a current picture) may be used as a reference area of block based compensation, such as in an intra block copy, an intra template matching prediction (IntraTMP) mode, or the like.

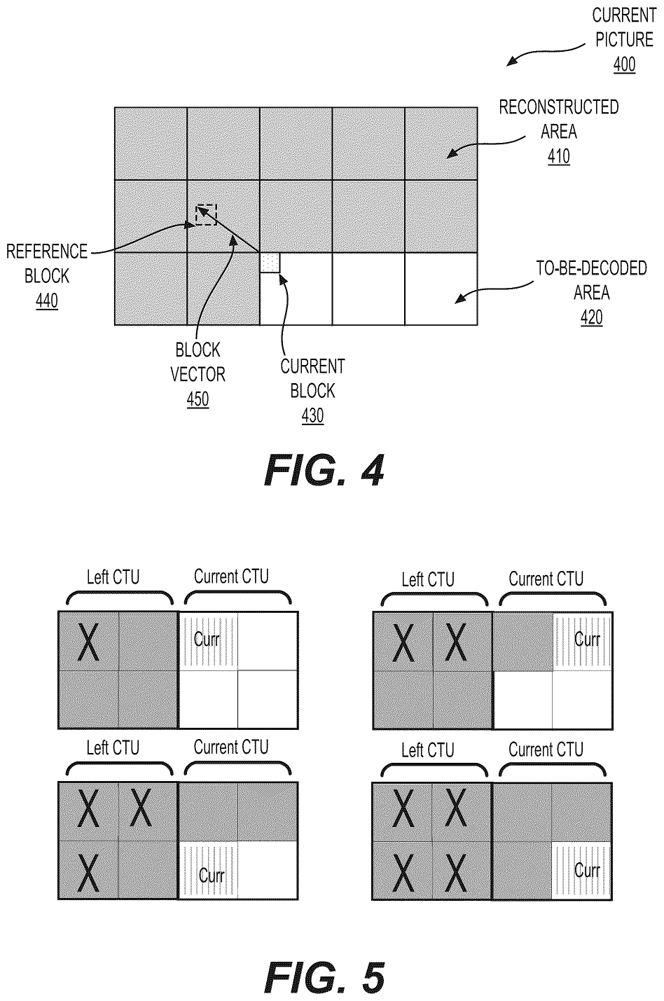

In an aspect, block based compensation from a different picture may be referred to as motion compensation. Similarly, a block compensation can be performed from a previously reconstructed area within the same picture, which may include intra picture block compensation (also referred to as current picture referencing (CPR) or the IBC mode). FIG. 4 shows an example of intra picture block compensation such as the IBC mode according to an aspect of the disclosure. A displacement vector that indicates an offset between a current block (430) and a reference block (440) may be referred as a block vector (BV) (450). The current block (430) and the reference block (440) are in a current picture (400).

Different from a motion vector (MV) in motion compensation, which can be at any value (positive or negative, at either x or y direction), a BV may have a few constraints such that the pointed reference block is available and is already reconstructed. In an example, referring to FIG. 4, the current picture (400) may include a to-be-decoded area (420) and a reconstructed area (410). In an example, a BV may be constrained to point to a reference block in the reconstructed area (410). In some examples, for parallel processing consideration, some reference area that is tile boundary or wavefront ladder shape boundary may be excluded.

The coding of a BV may be either explicit or implicit. In the explicit mode (referred to as an AMVP mode in inter coding), a difference between a BV and a BV predictor may be signaled; in the implicit mode, the BV may be recovered purely from the BV predictor, in a similar way as an MV in a merge mode. The resolution of a BV, in some implementations, may be restricted to integer positions; in other systems, the resolution of a BV may be allowed to point to fractional positions.

The use of intra block copy at a block level, can be signaled using a block level flag, refer as an IBC flag. In an aspect, the IBC flag is signaled when the current block is not coded in the merge mode. In an example, the IBC flag can be signaled by a reference index approach, for example, by treating the current decoded picture as a reference picture. In an example, such as in HEVC SCC, such a reference picture (e.g., the current decoded picture) is put in the last position of a list (e.g., a reference picture list). The special reference picture (e.g., the current decoded picture) may be managed together with other temporal reference pictures in a decoded picture buffer (DPB).

There may be some variations for intra block copy, such as treating the intra block copy as a third mode, which is different from either the intra prediction mode or the inter prediction mode. By treating the intra block copy as the third mode, the block vector prediction in the merge mode and the AMVP mode may be separated from the regular inter mode. In an example, the explicit mode described above may be referred to as an IBC AMVP mode, and the implicit mode described above may be referred to as an IBC merge mode. For example, a separate merge candidate list is defined for the IBC mode (e.g., the IBC merge mode), where all the entries in the list are all BVs. Similarly, in an example, the block vector prediction list in the IBC AMVP mode only consists of BVs. In some examples, the general rules applied to both lists include: both lists may follow the same logic as the inter merge candidate list used in the inter mode or the AMVP predictor list used in the inter mode in terms of candidate derivation process. For example, the 5 spatial neighboring locations in inter merge mode such as HEVC or VVC inter merge mode may be accessed for the IBC mode to derive its own merge candidate list.

FIG. 5 shows an example of intra picture block compensation with one CTU size search range and in some examples reuse of the memory for searching some part of a left CTU according to an aspect of the disclosure.

In some examples, such as in VVC, the search range of the IBC mode is constrained to be within a current CTU. In an example, the effective memory requirement to store reference samples for the IBC mode is one CTU size of samples. Considering the existing reference sample memory to store reconstructed samples in a current 64×64 region, 3 more 64×64 sized reference sample memory may be used. Thus, a method may be used to extend the effective search range of the IBC mode to some part of a left CTU while the total memory requirement for storing reference pixels may be kept unchanged, e.g., the total memory requirement is 1 CTU size, such as 4 of 64×64 reference sample memory in total. FIG. 5 shows an example of such a memory reuse mechanism. Each vertical stripped block is a current coding region (Curr), samples in each grey area are coded samples, the cross out regions (marked with “X”) are not available for reference as the cross out regions may be replaced in the reference sample memory by the coding regions in a current CTU.

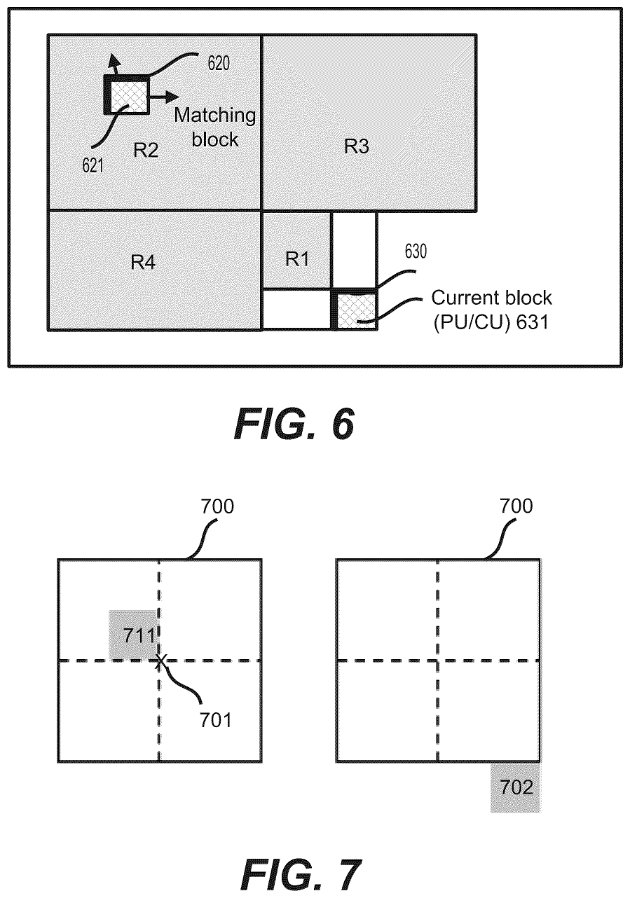

FIG. 6 shows an example of the IntraTMP mode according to an aspect of the disclosure. In an example, the IntraTMP mode is a special intra prediction mode. In an example, the IntraTMP mode is different from the intra prediction mode. Referring to FIG. 6, in an example of the IntraTMP mode, a prediction block (621) such as the best prediction block from a reconstructed part of a current frame may be copied. A template (620) such as an L-shaped template of the prediction block (621) may match a current template (630) of a current block (631). For a predefined search range, the encoder may search for the most similar template to the current template (630) in the reconstructed part of the current frame and may use the corresponding block (621) as a prediction block. In an example, the encoder then signals the usage of the IntraTMP mode, and the same prediction operation is performed at the decoder side.

Referring to FIG. 6, the prediction signal may be generated by matching the L-shaped causal neighbor of the current block (631) with another block in a predefined search area. In an example, the predefined search area includes or consists of: R1 that is a current CTU, R2 that is a top-left CTU of the current CTU, R3 that is an above CTU of the current CTU, and R4 that is a left CTU of the current CTU. In an example, a sum of absolute differences (SAD) is used as a cost function.

Within each region, the decoder may search for a template that has a least cost (e.g., a least SAD) with respect to the current template and may use a block corresponding to the least cost as a prediction block.

The dimensions of all regions (SearchRange_w, SearchRange_h) may be set to be proportional to a block dimension (BlkW, BlkH) to have a fixed number of SAD comparisons per pixel. In an example, SearchRange_w=a×BlkW, and SearchRange_h=a×BlkH, where ‘a’ is a constant that controls a trade-off between gain and complexity. In an example, ‘a’ is equal to 5.

To speed-up the template matching process, in some example, the search range of all search regions is subsampled, for example, by a factor of 2, and thus leading to a reduction of template matching search by 4. After finding the best match, a refinement process may be performed. The refinement process may be performed via a second template matching search around the best match with a reduced range. In an example, the reduced range is defined as min (BlkW, BlkH)/2.

The Intra template matching tool may be enabled for CUs with a size less than or equal to 64 in width and height. The maximum CU size for the IntraTMP mode may be configurable. The IntraTMP mode may be signaled at a CU level through a dedicated flag, for example, when decoder-side intra mode derivation (DIMD) is not used for the current CU.

In some examples, such as in some ECM applications, BV candidates used in a BV candidate list in the IBC mode (such as the IBC skip mode, the IBC merge mode, or the IBC AMVP mode), the IntraTMP mode, and the like can be derived from spatial candidates, HBVP candidates, pairwise average candidates (e.g., combine spatial and HBVP candidates), and some predefined BV candidates (e.g., (0,0)). Temporal BVs may be used in some related methods. However, in some examples, temporal MVs and temporal BVs are not used to derive BV candidates in a BV candidate list.

Aspects of the disclosure provide techniques, apparatuses, and methods related to BV candidate construction using temporal candidates, such as a temporal MV, a temporal BV, and/or the like, for example, in a BV candidate list. Determining BV candidate(s) in a BV candidate list using temporal candidates (e.g., a temporal MV or a temporal BV) may improve the prediction accuracy of BV. In an example, determining BV candidate(s) in a BV candidate list using temporal candidates may add diversity to the BV candidate list, and thus an encoder has more choices of BV candidates and may obtain a more accurate BV candidate. In an aspect, the techniques, apparatuses, and methods described in the disclosure may be used in the IBC mode or another prediction mode which utilizes the current picture (also referred to as the current coding frame) as a reference area of motion compensation, such as the IntraTMP mode.

The methods, aspects, and examples described in the disclosure may be used separately or combined in any order. The term “the IBC mode” may refer to the IBC mode described in the disclosure or a variant. The term “the IntraTMP mode” may refer to the IntraTMP mode described in the disclosure or a variant. Further, the methods, aspects, and examples may be implemented by processing circuitry (e.g., one or more processors or one or more integrated circuits). In one example, the one or more processors execute a program that is stored in a non-transitory computer-readable medium.

In an aspect, a prediction mode may be used to predict a current block in a current picture from a reference block that is in a previously reconstructed area of the same current picture, and an offset between the current block and the reference block may be referred as a BV. The prediction mode may be the IBC mode or a variant of the IBC mode, the IntraTMP mode or a variant of the IntraTMP mode, or the like. In various examples, to predict the current block, a candidate list including BV candidate(s), such as a BV candidate list, may be constructed in the prediction mode (e.g., the IBC mode, the IntraTMP mode, or the like), and a BV candidate may be selected from the BV candidate list to determine a BV of the current block. The reference block can be determined based on the BV, and the current block may be predicted from the reference block.

According to an aspect of the disclosure, a current block is predicted using the prediction mode described above, such as one of the IBC mode and the IntraTMP mode. A first temporal BV candidate for a BV candidate list of the current block may be determined based on one of (i) motion information and (ii) BV information associated with a collocated block (also interchangeably referred to as a co-located block) in a collocated picture (also interchangeably referred to as a co-located picture) of the current picture. The BV candidate list may be constructed based on the first temporal BV candidate. A current sample may be reconstructed based on the BV candidate list using the one of the IBC mode and the IntraTMP mode.

In an example, the collocated picture is already reconstructed. The one of (i) the motion information and (ii) the BV information associated with the collocated block is used to reconstruct samples in an area within the collocated block or adjacent to the collocated block.

In an aspect, the motion information associated with the collocated block in the collocated picture may be referred to as temporal motion information. The temporal motion information may include or indicate a temporal MV pointing to a reference block in a reference picture, a reference index indicating the reference picture, and the like.

In an aspect, the BV information associated with the collocated block in the collocated picture may be referred to as temporal BV information. The temporal BV information may include or indicate a temporal BV pointing to a reference block, for example, in the collocated picture.

In an aspect, the temporal motion information (e.g., including or indicating the temporal MV) or the temporal BV information (e.g., including or indicating the temporal BV) may be used to derive a BV candidate for the current block. The BV candidate derived from the temporal motion information or the temporal BV information may be referred to as a temporal BV candidate, such as the first temporal BV candidate described above. In some examples, the temporal BV candidate may be derived by fetching the motion information (or the temporal motion information) or the BV information (or the temporal BV information) from the collocated block in the collocated picture (e.g., the signaled collocated picture). In an example, the current picture is coded in an inter slice. The collocated picture may be a reference picture in a reference list for the current picture. An encoder may determine the collocated picture as a first reference picture that is closest to the current picture in the first reference list (e.g., L1), for example, based on a picture order count (POC) difference.

In an aspect, the derived motion information or the derived BV information may be fetched from a specific position (also referred to as a candidate position) of the collocated block in the collocated picture (e.g., the signaled collocated picture). For example, the derived motion information or the derived BV information is associated with the specific position of the collocated block. In an example, the first temporal BV candidate is determined based on the one of (i) the motion information and (ii) the BV information associated with the candidate position (e.g., a first candidate position) of the collocated block.

FIG. 7 shows examples of candidate positions for a temporal candidate such as a temporal BV candidate according to an aspect of the disclosure. The temporal candidate such as the temporal BV candidate may be referred to as a temporal merge candidate when the temporal candidate is used in the IBC skip mode, the IBC merge mode, or the like.

For example, the specific position or the candidate position of the collocated block (700) may be a center position (701) of the collocated block (700), a bottom-right position (702) of the collocated block (700), or the like as shown in FIG. 7. The center position (701) for the temporal candidate or the bottom-right position (702) for the temporal candidate (e.g., the temporal BV candidate) may be indicated by the respective gray blocks in FIG. 7. In an example, the one of the motion information and the BV information used to reconstruct samples in the block (711) (e.g., an area within the collocated block (700) that is indicated by the gray block) is the one of the motion information and the BV information associated with the candidate position (701), and may be used to derive the temporal BV candidate.

As described above, the collocated block (700) is in the collocated picture of the current picture. The collocated block (700) may be collocated with the current block. For example, if the current block is positioned at (x0, y0) of the current picture, the collocated block may be positioned at (x0, y0) of the collocated picture.

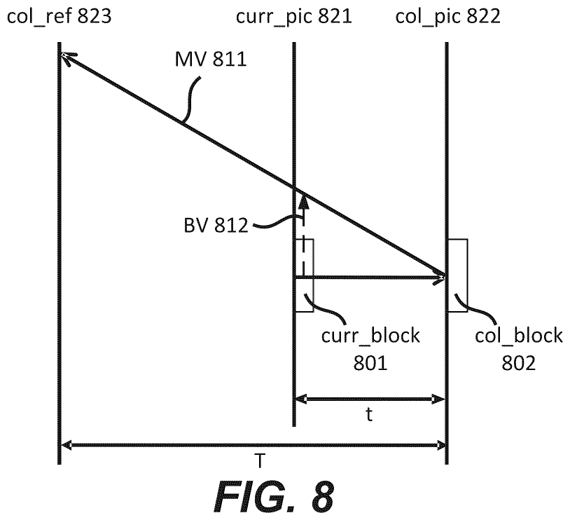

In an aspect, the temporal motion information from the collocated block in the collocated picture may be scaled. FIG. 8 shows an example of MV scaling for a temporal BV candidate (e.g., a temporal merge candidate) according to an aspect of the disclosure. A current block (801) is in a current picture (821). A collocated block (802) of the current block (801) is in a collocated picture (822) of the current picture (821). A temporal BV candidate indicating a BV (812) may be derived from temporal motion information associated with a candidate position of the collocated block (802). The temporal motion information associated with the candidate position of the collocated block (802) may include an MV (811), for example, pointing from the collocated picture (822) to a reference picture (823) of the collocated picture (822). In an example, the derived motion information may be a scaled MV, such as described below. The scaled MV for the temporal BV candidate (e.g., a temporal merge candidate) may be determined as shown by the dotted line in FIG. 8. In an example, the scaled MV may be determined (e.g., scaled) from the MV (811) of the collocated block (802) (e.g., the co-located CU) using POC distances t and T. The first POC distance t may be defined as the POC difference between a reference picture (e.g., the collocated picture (822)) of the current picture (821) and the current picture (821). The second POC distance T may be defined as the POC difference between the reference picture (823) of the collocated picture (or the co-located picture) (822) and the collocated picture (822). In an example, the scaled MV is a BV (812).

In an example, referring to FIG. 8, the scaled MV such as the BV (812) may be determined based on the MV (811), the first POC difference t between the current picture (821) and the collocated picture (822), and the second POC difference T between the reference picture (823) of the collocated picture (822) and the collocated picture (822). In an example, the first temporal BV candidate of the current block (801) includes the scaled MV (812).

In an aspect, more than one position or multiple candidate positions may be used to derive a BV candidate such as a temporal BV candidate. The derived BV candidate or the derived temporal BV candidate (e.g., the first temporal BV candidate) may be determined based on the multiple derived motion information from the respective multiple candidate positions, such as an average of the multiple derived motion information from the respective multiple candidate positions. In an example, the first temporal BV candidate is determined by averaging multiple pieces of motion information of the respective candidate positions associated with the collocated block.

In an example, the derived BV candidate or the derived temporal BV candidate (e.g., the first temporal BV candidate) may be an average of multiple pieces of BV information of respective candidate positions associated with the collocated block.

In an aspect, more than one candidate position may be used to generate a temporal candidate list. The temporal candidate list may also be referred to as the temporal BV candidate list because the temporal candidate list includes temporal BV candidate(s). The temporal candidate list may be used to construct the BV candidate list, for example, based on an order of the BV candidate list construction.

In an example, the temporal candidate list including the temporal BV candidates associated with respective candidate positions of the collocated block is generated. Each temporal BV candidate may be based on one of (i) the motion information and (ii) the BV information associated with the respective candidate position of the collocated block. The temporal BV candidates include the first temporal BV candidate described above.

In an example, five candidate positions of the collocated block are associated with respective motion information and/or BV information, from which five respective temporal BV candidates may be obtained. The temporal BV candidate list may include the five temporal BV candidates (e.g., candidates 1-5).

In an aspect, a template-matching (TM) process or the TM may be applied to reorder the temporal candidate list by using TM costs of the respective temporal BV candidates, for example, in an ascending order. In an example, a reference block in the current picture is determined based on each temporal BV candidate (e.g., a BV). A TM cost is obtained based on a current template of the current block and a reference template of the reference block. The current template may include neighboring reconstructed samples of the current block. In an example, the current template may include above reconstructed samples that are above the current block and/or left reconstructed samples that are to the left of the current block.

In an example, the TM is applied to determine the TM costs of the respective temporal BV candidates in the temporal candidate list. The temporal BV candidates in the temporal candidate list may be reordered based on the respective TM costs, and the BV candidate list may be constructed based on the reordered temporal candidate list. In an example, the first m temporal candidates of the reordered temporal BV candidates may be selected and added to the BV candidate list where m is a positive integer that is less than or equal to a size of temporal candidate list (e.g., a total of temporal BV candidates in the temporal candidate list).

In an example, when the temporal BV candidate list includes the five temporal BV candidates (e.g., candidates 1-5), five TM costs may be obtained. In an example, the temporal candidate list is reordered based on the five TM costs in an ascending order. In an example, the candidates 1-5 may be ranked as the candidate 5, the candidate 3, the candidate 1, the candidate 2, the candidate 4 in the ascending order. If m=2, then the candidates 5 and 3 are added to the BV candidate list.

In an aspect, the TM process may be applied to the temporal candidate list to select the best n1 candidates with the smallest TM cost(s). The value n is a positive number. In an example, the value n is less than or equal to the size of temporal candidate list.

In an example, the TM is applied to determine the TM costs of the respective temporal BV candidates in the temporal candidate list. The n temporal BV candidates may be selected based on the TM costs where the TM costs of the n temporal BV candidates are not larger than the TM cost of each remaining temporal BV candidate in the temporal candidate list. The BV candidate list may be constructed based on the n selected temporal BV candidates.

In an aspect, the temporal BV candidate(s) derived from the motion information (e.g., including an MV) from the collocated picture may be used to construct the BV candidate list based on the order of the BV candidate list construction.

In an aspect, the TM process may be applied to determine TM costs of respective BV candidates in an initial BV candidate list, and the BV candidates include the first temporal BV candidate. The BV candidate list may be constructed by reordering the BV candidates in the initial BV candidate list based on the respective TM costs.

In an example, the TM process may be applied to reorder the BV candidate list (e.g., the initial BV candidate list) by using the TM costs, for example, in an ascending order. In an example, the BV candidate list includes BV candidates where the BV candidates may include the temporal BV candidate(s) and/or non-temporal BV candidate(s). The non-temporal BV candidate(s) may be derived from spatial neighboring block(s) in the current picture or may include predefined BV candidate(s). In an example, the non-temporal BV candidate(s) include spatial candidate(s), HBVP candidate(s), pairwise average candidate(s), the predefined BV candidate(s), and the like. The TM costs of the respective BV candidates may be determined using the TM process such as described above. In an example, the BV candidate list (and the BV candidates) is reordered based on the TM costs in the ascending order.

In an example, the TM process is applied to the BV candidate list to select the best n2 candidates with the smallest TM cost(s). The value n2 is a positive number. In an example, the value n2 is less than or equal to the size of BV candidate list. In an example, the TM process is applied to determine TM costs of respective BV candidates in the BV candidate list. The BV candidates includes the first temporal BV candidate. The n2 BV candidates may be selected based on the TM costs. The TM costs of the n2 BV candidates are not larger than the TM cost of each remaining BV candidate in the BV candidate list. The current sample may be reconstructed based on the n2 selected BV candidates using the one of the IBC mode and the IntraTMP mode.

In an aspect, when the BV candidate list including the first temporal BV candidate is constructed, the current block is coded based on the BV candidate list. In an example, one of the BV candidates is selected to code the current block. The one of the BV candidates may be the first temporal BV candidate. The BV of the current block may be determined based on the first temporal BV candidate. In an example, the BV of the current block is a BV or a scaled MV in the first temporal BV candidate. When the BV is determined, the current block may be reconstructed based on the BV.

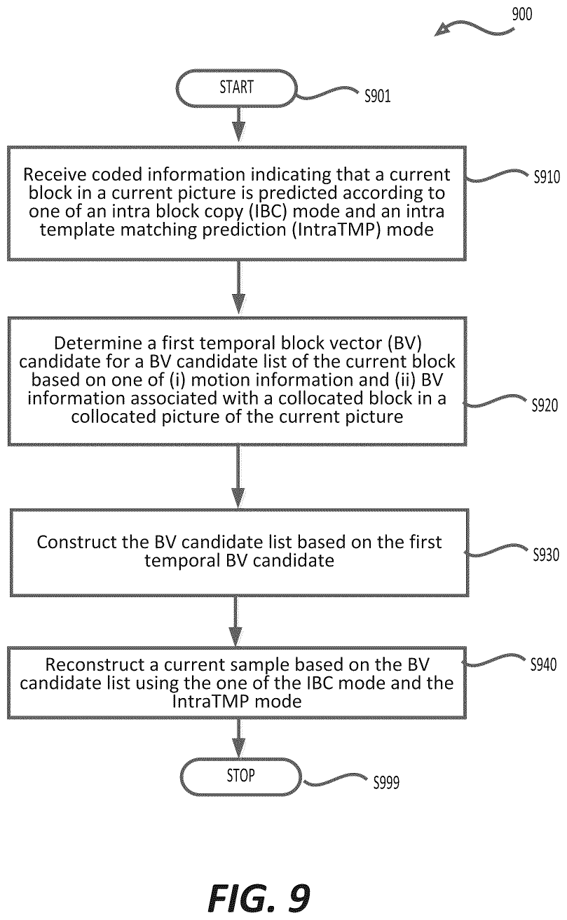

FIG. 9 shows a flow chart outlining a process (900) according to an aspect of the disclosure. The process (900) can be used in an apparatus, such as a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), coded information is received. The coded information indicates that a current block in a current picture is predicted according to a prediction mode where the current block is predicted from a reference block that is in a previously reconstructed area of the same current picture.

In an aspect, the prediction mode is one of the IBC mode and the IntraTMP mode. In an example, the one of the IBC mode and the IntraTMP mode is the IBC mode. the one of the IBC mode and the IntraTMP mode is the IntraTMP mode.

In an example, the current picture is coded in an inter slice.

At (S920), a first temporal BV candidate for a BV candidate list of the current block is determined based on one of (i) motion information and (ii) BV information associated with a collocated block in a collocated picture of the current picture.

In an aspect, the first temporal BV candidate is determined based on the one of (i) the motion information and (ii) the BV information associated with a first candidate position of the collocated block, such as shown in FIG. 7.

In an aspect, referring to FIG. 8, the one of (i) the motion information and (ii) the BV information is the motion information that indicates an MV (e.g., the MV (811)) and a corresponding reference picture (e.g., the reference picture (823)) of the collocated picture (e.g., the collocated picture (822)). A scaled MV (e.g., the BV (812)) is determined based on the MV (e.g., the MV (811)), a first POC difference (e.g., the first POC difference t) between the current picture (e.g., (821)) and the collocated picture (e.g., (822)), and a second POC difference (e.g., the second POC difference T) between the reference picture (e.g., (823)) of the collocated picture and the collocated picture (e.g., (822)). In an example, the first temporal BV candidate includes the scaled MV.

In an aspect, referring to FIG. 7, when the one of (i) the motion information and (ii) the BV information is the motion information associated with the collocated block, the first temporal BV candidate is determined by averaging multiple pieces of motion information of respective candidate positions (e.g., the candidate positions (701)-(702)) associated with the collocated block (e.g., (700)). When the one of (i) the motion information and (ii) the BV information is the BV information associated with the collocated block, the first temporal BV candidate is determined by averaging multiple pieces of BV information of respective candidate positions (e.g., the candidate positions (701)-(702)) associated with the collocated block (e.g., (700)).

At (S930), the BV candidate list is constructed based on the first temporal BV candidate. The BV candidate list of the current block may include BV candidates such as temporal BV candidate(s) and non-temporal BV candidate(s) as described above. The temporal BV candidate(s) include the first temporal BV candidate.

In an aspect, a temporal candidate list including temporal BV candidates associated with respective candidate positions of the collocated block is generated. The temporal BV candidates include the first temporal BV candidate. Each temporal BV candidate may be based on one of (i) the motion information and (ii) the BV information associated with the respective candidate position of the collocated block. The BV candidate list is constructed based on the temporal candidate list.

In an example, the TM is applied to determine TM costs of the respective temporal BV candidates in the temporal candidate list, the temporal BV candidates in the temporal candidate list are reordered based on the respective TM costs, and the BV candidate list is constructed based on the reordered temporal candidate list, for example, by adding the first m reordered temporal candidates from the reordered temporal candidate list to the BV candidate list as described above.

In an example, the TM is applied to determine TM costs of the respective temporal BV candidates in the temporal candidate list. n1 temporal BV candidates are selected based on the TM costs. TM costs of the n1 temporal BV candidates are not larger than the TM cost of each remaining temporal BV candidate in the temporal candidate list. The BV candidate list is constructed based on the n1 selected temporal BV candidates.

In an aspect, the TM is applied to determine TM costs of respective BV candidates in an initial BV candidate list. The BV candidates include the first temporal BV candidate. The BV candidate list is constructed by reordering the BV candidates in the initial BV candidate list based on the respective TM costs. In this example, the initial BV candidate list and the BV candidate list include the same BV candidates that may be arranged in different orders.

In an aspect, the TM is applied to determine TM costs of respective BV candidates in the BV candidate list. The BV candidates include the first temporal BV candidate. n2 BV candidates are selected based on the TM costs. The TM costs of the n2 BV candidates are not larger than the TM cost of each remaining BV candidate in the BV candidate list. The current sample may be reconstructed based on the n2 selected BV candidates using the one of the IBC mode and the IntraTMP mode.

At (S940), a current sample is reconstructed based on the BV candidate list using the one of the IBC mode and the IntraTMP mode.

Then, the process proceeds to (S999) and terminates.

The process (900) can be suitably adapted. Step(s) in the process (900) can be modified and/or omitted. Additional step(s) can be added. Any suitable order of implementation can be used.

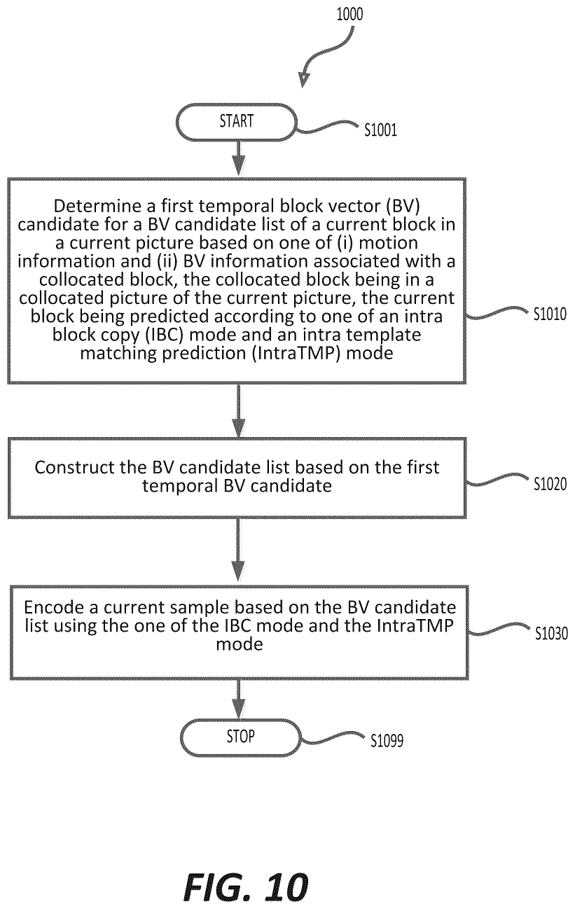

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (103), the processing circuitry that performs functions of the video encoder (303), and the like. In some aspects, the process (1000) is implemented in software instructions, thus when the processing circuitry executes the software instructions, the processing circuitry performs the process (1000). The process starts at (S1001) and proceeds to (S1010).

At (S1010), a first temporal block vector (BV) candidate for a BV candidate list of a current block in a current picture is determined based on one of (i) motion information and (ii) BV information associated with a collocated block, the collocated block being in a collocated picture of the current picture. The current block may be predicted according to one of the IBC mode and the IntraTMP mode. In an example, the one of (i) the motion information and (ii) the BV information is associated with a first candidate position of the collocated block.

In an aspect, referring to FIG. 8, the one of (i) the motion information and (ii) the BV information is the motion information that indicates an MV (e.g., the MV (811)) and a corresponding reference picture (e.g., the reference picture (823)) of the collocated picture (e.g., the collocated picture (822)). A scaled MV (e.g., the BV (812)) is determined based on the MV (e.g., the MV (811)), a first POC difference (e.g., the first POC difference t) between the current picture (e.g., (821)) and the collocated picture (e.g., (822)), and a second POC difference (e.g., the second POC difference T) between the reference picture (e.g., (823)) of the collocated picture and the collocated picture (e.g., (822)). In an example, the first temporal BV candidate includes the scaled MV.

In an aspect, referring to FIG. 7, when the one of (i) the motion information and (ii) the BV information is the motion information associated with the collocated block, the first temporal BV candidate is determined by averaging multiple pieces of motion information of respective candidate positions (e.g., the candidate positions (701)-(702)) associated with the collocated block (e.g., (700)). When the one of (i) the motion information and (ii) the BV information is the BV information associated with the collocated block, the first temporal BV candidate is determined by averaging multiple pieces of BV information of respective candidate positions (e.g., the candidate positions (701)-(702)) associated with the collocated block (e.g., (700)).

At (S1020), the BV candidate list is constructed based on the first temporal BV candidate. The BV candidate list of the current block may include BV candidates such as temporal BV candidate(s) and non-temporal BV candidate(s) as described above. The temporal BV candidate(s) include the first temporal BV candidate.

In an aspect, a temporal candidate list including temporal BV candidates associated with respective candidate positions of the collocated block is generated. The temporal BV candidates include the first temporal BV candidate. Each temporal BV candidate may be based on one of (i) the motion information and (ii) the BV information associated with the respective candidate position of the collocated block. The BV candidate list is constructed based on the temporal candidate list.

In an example, the TM is applied to determine TM costs of the respective temporal BV candidates in the temporal candidate list, the temporal BV candidates in the temporal candidate list are reordered based on the respective TM costs, and the BV candidate list is constructed based on the reordered temporal candidate list, for example, by adding the first m reordered temporal candidates from the reordered temporal candidate list to the BV candidate list as described above.

In an example, the TM is applied to determine TM costs of the respective temporal BV candidates in the temporal candidate list. n1 temporal BV candidates are selected based on the TM costs. TM costs of the n1 temporal BV candidates are not larger than the TM cost of each remaining temporal BV candidate in the temporal candidate list. The BV candidate list is constructed based on the n1 selected temporal BV candidates.

In an aspect, the TM is applied to determine TM costs of respective BV candidates in an initial BV candidate list. The BV candidates include the first temporal BV candidate. The BV candidate list is constructed by reordering the BV candidates in the initial BV candidate list based on the respective TM costs. In this example, the initial BV candidate list and the BV candidate list include the same BV candidates that may be arranged in different orders.

At (S1030), a current sample is encoded based on the BV candidate list using the one of the IBC mode and the IntraTMP mode.

Then, the process proceeds to (S1099) and terminates.

The process (1000) can be suitably adapted. Step(s) in the process (1000) can be modified and/or omitted. Additional step(s) can be added. Any suitable order of implementation can be used.

In an aspect, a method of processing visual media data includes processing a bitstream of visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information indicating that a current block in a current picture is predicted according to one of an intra block copy (IBC) mode and an intra template matching prediction (IntraTMP) mode. The format rule specifies that a first temporal block vector (BV) candidate is determined for a BV candidate list of the current block based on one of (i) motion information and (ii) BV information associated with a collocated block in a collocated picture of the current picture. The format rule specifies that the BV candidate list is constructed based on the first temporal BV candidate. The format rule specifies that a current sample is processed based on the BV candidate list using the one of the IBC mode and the IntraTMP mode.

In an example, the one of (i) the motion information and (ii) the BV information is associated with a first candidate position of the collocated block.

In an example, the format rule specifies that when the one of (i) the motion information and (ii) the BV information is the motion information that indicates a motion vector (MV) and a corresponding reference picture of the collocated picture, a scaled MV is determined based on the MV, a first picture order count (POC) difference between the current picture and the collocated picture, and a second POC difference between the reference picture of the collocated picture and the collocated picture, and the first temporal BV candidate includes the scaled MV.

In an example, the format rule specifies that a temporal candidate list including temporal BV candidates associated with respective candidate positions of the collocated block is generated. Each temporal BV candidate is based on one of (i) motion information and (ii) BV information associated with the respective candidate position of the collocated block, the temporal BV candidates including the first temporal BV candidate. The

TM is applied to determine TM costs of the respective temporal BV candidates in the temporal candidate list. The BV candidate list is constructed based on n1 temporal BV candidates where TM costs of the n1 temporal BV candidates are not larger than one or more TM costs of remaining temporal BV candidates in the temporal candidate list.

Aspects, examples, and/or methods in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

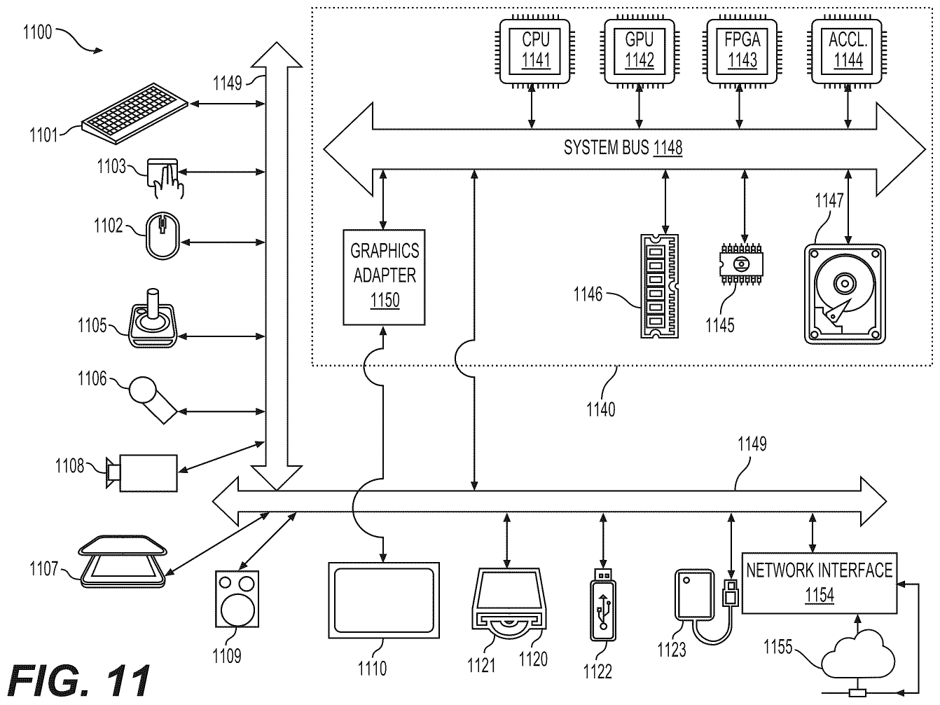

The techniques described above, can be implemented as computer software using computer-readable instructions and physically stored in one or more computer-readable media. For example, FIG. 11 shows a computer system (1100) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 11 for computer system (1100) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1100).

Computer system (1100) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1101), mouse (1102), trackpad (1103), touch screen (1110), data-glove (not shown), joystick (1105), microphone (1106), scanner (1107), camera (1108).

Computer system (1100) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1110), data-glove (not shown), or joystick (1105), but there can also be tactile feedback devices that do not serve as input devices), audio output devices (such as: speakers (1109), headphones (not depicted)), visual output devices (such as screens (1110) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1100) can also include human accessible storage devices and their associated media such as optical media including CD/DVD ROM/RW (1120) with CD/DVD or the like media (1121), thumb-drive (1122), removable hard drive or solid state drive (1123), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1100) can also include an interface (1154) to one or more communication networks (1155). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1149) (such as, for example USB ports of the computer system (1100)); others are commonly integrated into the core of the computer system (1100) by attachment to a system bus as described below (for example Ethernet interface into a PC computer system or cellular network interface into a smartphone computer system). Using any of these networks, computer system (1100) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1140) of the computer system (1100).

The core (1140) can include one or more Central Processing Units (CPU) (1141), Graphics Processing Units (GPU) (1142), specialized programmable processing units in the form of Field Programmable Gate Areas (FPGA) (1143), hardware accelerators for certain tasks (1144), graphics adapters (1150), and so forth. These devices, along with Read-only memory (ROM) (1145), Random-access memory (1146), internal mass storage such as internal non-user accessible hard drives, SSDs, and the like (1147), may be connected through a system bus (1148). In some computer systems, the system bus (1148) can be accessible in the form of one or more physical plugs to enable extensions by additional CPUs, GPU, and the like. The peripheral devices can be attached either directly to the core's system bus (1148), or through a peripheral bus (1149). In an example, the screen (1110) can be connected to the graphics adapter (1150). Architectures for a peripheral bus include PCI, USB, and the like.

CPUs (1141), GPUs (1142), FPGAs (1143), and accelerators (1144) can execute certain instructions that, in combination, can make up the aforementioned computer code. That computer code can be stored in ROM (1145) or RAM (1146). Transitional data can also be stored in RAM (1146), whereas permanent data can be stored for example, in the internal mass storage (1147). Fast storage and retrieve to any of the memory devices can be enabled through the use of cache memory, that can be closely associated with one or more CPU (1141), GPU (1142), mass storage (1147), ROM (1145), RAM (1146), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1100), and specifically the core (1140) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1140) that are of non-transitory nature, such as core-internal mass storage (1147) or ROM (1145). The software implementing various aspects of the present disclosure can be stored in such devices and executed by core (1140). A computer-readable medium can include one or more memory devices or chips, according to particular needs. The software can cause the core (1140) and specifically the processors therein (including CPU, GPU, FPGA, and the like) to execute particular processes or particular parts of particular processes described herein, including defining data structures stored in RAM (1146) and modifying such data structures according to the processes defined by the software. In addition or as an alternative, the computer system can provide functionality as a result of logic hardwired or otherwise embodied in a circuit (for example: accelerator (1144)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
receive coded information indicating that a current block in a current picture is predicted according to one of an intra block copy (IBC) mode and an intra template matching prediction (IntraTMP) mode;
determine a first temporal block vector (BV) candidate for a BV candidate list of the current block based on one of (i) motion information and (ii) BV information associated with a collocated block in a collocated picture of the current picture;
construct the BV candidate list based on the first temporal BV candidate; and
reconstruct a current sample based on the BV candidate list using the one of the IBC mode and the IntraTMP mode.

2. The apparatus of claim 1, wherein the processing circuitry is configured to:
determine the first temporal BV candidate based on the one of (i) the motion information and (ii) the BV information associated with a first candidate position of the collocated block.

3. The apparatus of claim 1, wherein
the one of (i) the motion information and (ii) the BV information is the motion information that indicates a motion vector (MV) and a corresponding reference picture of the collocated picture;
the processing circuitry is configured to determine a scaled MV based on the MV, a first picture order count (POC) difference between the current picture and the collocated picture, and a second POC difference between the reference picture of the collocated picture and the collocated picture; and
the first temporal BV candidate includes the scaled MV.

4. The apparatus of claim 1, wherein the processing circuitry is configured to:
when the one of (i) the motion information and (ii) the BV information is the motion information associated with the collocated block, determine the first temporal BV candidate by averaging multiple pieces of motion information of respective candidate positions associated with the collocated block; and
when the one of (i) the motion information and (ii) the BV information is the BV information associated with the collocated block, determine the first temporal BV candidate by averaging multiple pieces of BV information of respective candidate positions associated with the collocated block.

5. The apparatus of claim 1, wherein the processing circuitry is configured to:
generate a temporal candidate list including temporal BV candidates associated with respective candidate positions of the collocated block, each temporal BV candidate being based on one of (i) the motion information and (ii) the BV information associated with the respective candidate position of the collocated block, the temporal BV candidates including the first temporal BV candidate; and
construct the BV candidate list based on the temporal candidate list.

6. The apparatus of claim 5, wherein the processing circuitry is configured to:
construct the BV candidate list by applying template-matching (TM) to the temporal candidate list.

7. The apparatus of claim 5, wherein the processing circuitry is configured to:
apply template-matching (TM) to determine TM costs of the respective temporal BV candidates in the temporal candidate list;
reorder the temporal BV candidates in the temporal candidate list based on the respective TM costs; and
construct the BV candidate list based on the reordered temporal candidate list.

8. The apparatus of claim 5, wherein the processing circuitry is configured to:
apply template-matching (TM) to determine TM costs of the respective temporal BV candidates in the temporal candidate list;
select n1 temporal BV candidates based on the TM costs, TM costs of the n1 temporal BV candidates not being larger than the TM cost of each remaining temporal BV candidate in the temporal candidate list, n1 being less than a total number of the temporal BV candidates; and
construct the BV candidate list based on the n1 selected temporal BV candidates.

9. The apparatus of claim 1, wherein the processing circuitry is configured to:
apply template-matching (TM) to determine TM costs of respective BV candidates in an initial BV candidate list, the BV candidates including the first temporal BV candidate; and
construct the BV candidate list by reordering the BV candidates in the initial BV candidate list based on the respective TM costs.

10. The apparatus of claim 1, wherein the processing circuitry is configured to:
apply template-matching (TM) to determine TM costs of respective BV candidates in the BV candidate list, the BV candidates including the first temporal BV candidate;
select n2 BV candidates based on the TM costs, the TM costs of the n2 BV candidates not being larger than the TM cost of each remaining BV candidate in the BV candidate list, n2 being less than a total number of the BV candidates in the BV candidate list; and
reconstruct the current sample based on the n2 selected BV candidates using the one of the IBC mode and the IntraTMP mode.

11. A method for video encoding, comprising:
determining a first temporal block vector (BV) candidate for a BV candidate list of a current block in a current picture based on one of (i) motion information and (ii) BV information associated with a collocated block, the collocated block being in a collocated picture of the current picture, the current block being predicted according to one of an intra block copy (IBC) mode and an intra template matching prediction (IntraTMP) mode;
constructing the BV candidate list based on the first temporal BV candidate; and
encoding a current sample based on the BV candidate list using the one of the IBC mode and the IntraTMP mode.

12. The method of claim 11, wherein the determining the first temporal BV candidate comprises:
determining the first temporal BV candidate based on the one of (i) the motion information and (ii) the BV information associated with a first candidate position of the collocated block.

13. The method of claim 11, wherein
the one of (i) the motion information and (ii) the BV information is the motion information that indicates a motion vector (MV) and a corresponding reference picture of the collocated picture;
the determining the first temporal BV candidate includes determining a scaled MV based on the MV, a first picture order count (POC) difference between the current picture and the collocated picture, and a second POC difference between the reference picture of the collocated picture and the collocated picture; and
the first temporal BV candidate includes the scaled MV.

14. The method of claim 11, wherein the determining the first temporal BV candidate comprises:
when the one of (i) the motion information and (ii) the BV information is the motion information associated with the collocated block, determining the first temporal BV candidate by averaging multiple pieces of motion information of respective candidate positions associated with the collocated block; and
when the one of (i) the motion information and (ii) the BV information is the BV information associated with the collocated block, determining the first temporal BV candidate by averaging multiple pieces of BV information of respective candidate positions associated with the collocated block.

15. The method of claim 11, wherein the constructing the BV candidate list comprises:
generating a temporal candidate list including temporal BV candidates associated with respective candidate positions of the collocated block, each temporal BV candidate being based on one of (i) the motion information and (ii) the BV information associated with the respective candidate position of the collocated block, the temporal BV candidates including the first temporal BV candidate; and
constructing the BV candidate list based on the temporal candidate list.

16. The method of claim 15, wherein the constructing the BV candidate list comprises:
constructing the BV candidate list by applying template-matching (TM) to the temporal candidate list.

17. The method of claim 15, wherein the constructing the BV candidate list comprises:
applying template-matching (TM) to determine TM costs of the respective temporal BV candidates in the temporal candidate list;
reordering the temporal BV candidates in the temporal candidate list based on the respective TM costs; and
constructing the BV candidate list based on the reordered temporal candidate list.

18. The method of claim 15, wherein the constructing the BV candidate list comprises:
applying template-matching (TM) to determine TM costs of the respective temporal BV candidates in the temporal candidate list;
selecting n1 temporal BV candidates based on the TM costs, TM costs of the n1 temporal BV candidates not being larger than the TM cost of each remaining temporal BV candidate in the temporal candidate list, n1 being less than a total number of the BV candidates in the BV candidate list; and
constructing the BV candidate list based on the n1 selected temporal BV candidates.

19. The method of claim 11, wherein the constructing the BV candidate list comprises:
applying template-matching (TM) to determine TM costs of respective BV candidates in an initial BV candidate list, the BV candidates including the first temporal BV candidate; and
constructing the BV candidate list by reordering the BV candidates in the initial BV candidate list based on the respective TM costs.

20. A non-transitory computer readable medium storing a video media bitstream encoded by an encoding method, the encoding method comprising:
determining a first temporal block vector (BV) candidate for a BV candidate list of a current block in a current picture based on one of (i) motion information and (ii) BV information associated with a collocated block, the collocated block being in a collocated picture of the current picture, the current block being predicted according to one of an intra block copy (IBC) mode and an intra template matching prediction (IntraTMP) mode;
constructing the BV candidate list based on the first temporal BV candidate; and
encoding a current sample based on the BV candidate list using the one of the IBC mode and the IntraTMP mode.
